(19) United States
(12) Patent Application Publication
(10) Pub. No.: US 2008/0056326 A1
(43) Pub. Date: Mar. 6, 2008

(54) Process And Apparatus For Laser Selective Separation

(75) Inventors: Jun DUAN, Singapore (SG); Wee Sing CHOK, Singapore (SG); Jui Kiat GOH, Singapore (SG); Wee Hong TAN, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: LaserResearch (S) Pte Ltd, The Strategy (SG)

(21) Appl. No.: 11/842,163

(22) Filed: Aug. 21, 2007

Related U.S. Application Data
(60) Provisional application No. 60/823,094, filed on Aug. 21, 2006.

(51) Int. Cl. H01S 3/08; B29C 63/00

(52) U.S. Cl. 372/99; 156/344

(57) ABSTRACT

The present invention provides a laser selective separation apparatus for separating two bonded parts being bonding together at a joint by bonding material. The present invention further provides a process for separating two bonded parts being bonding together at a joint by bonding material.

### RELATED APPLICATION

This application claims the benefit under 35 U.S.C. 119(e) of U.S. Provisional Application Ser. No. 60/823,094 filed on 21 Aug. 2006, which is incorporated herein by reference.

### FIELD OF THE INVENTION

The present invention generally relates to laser technologies and, more particularly to an apparatus that employs laser beams to separate two bonded parts at the joint, and further to a process using the apparatus.

### BACKGROUND OF THE INVENTION

Many electronic products including TVs, PC monitors, and monitors used in specialist applications use a Cathode-Ray Tube (CRT) for projecting and displaying electronic images. A CRT comprises a front screen panel, a conical funnel section and a neck section, where the conical funnel and neck sections are usually manufactured into an integral part, and the integral part and the front screen panel are usually bonded together by frit materials such as organic resins. The joint formed by the frit materials is usually less than 0.2 mm. Due to different technical requirements, the front screen panel is typically made of non-leaded glass that contains high levels of barium oxide, and the conical funnel section and neck sections of leaded glass that contains high levels of lead oxide. In addition, a CRT includes ferrous and non-ferrous metals, and the coatings to different parts are different.

Along with the developments of new electronic products, more and more CRTs become waste. In addition, the waste CRTs may be defected ones from assembly lines. Studies have shown that when CRTs are disposed in landfill sites, lead can leach from the crushed glass and contaminate ground water. Thus, the waste CRTs have to be recycled for environmental protections. It is also important to reclaim the other commercially valuable materials, such as ferrous and non-ferrous metal and plastics which are associated with CRTs.

Mixed CRT glass from the front screen panel, conical funnel and neck sections contains on average 5% lead oxide, 10% barium oxide and 2% strontium oxide. It is not possible to use the mixed glass in screen panel manufacture because screen panels cannot contain even small amount of lead oxide since this will discolor the glass under X-radiation. In order to maximize the use of waste CRT glass in new CRTs or other high quality glass products, the CRTs have to be split apart in a way that guarantees that there is no leaded glass being attached to the screen glass.

There are attempts to separate the front panel screen from the conical funnel section of a CRT. U.S. Pat. No. 6,089,433, German patent DE4295404 and German patent DE4234706 disclose a method that uses a resistance wire to separate the front screen and conical funnel section. When a resistive wire is wrapped round a CRT and electrically heated it causes a thermal differential across the thickness of the glass. The wire has to be in contact with the glass surface for approximately 30 seconds. The heated area is then cooled (e.g. with a water-soaked sponge) to create thermal stress which results in a crack. The problems of this technique include the risk of sharp edges on the separated fractions, the difficulty in getting clean separation between screen and funnel section if the wire is incorrectly placed, and the occurrence of random glass breaking. U.S. Pat. No. 6,752,675 discloses a method that separates the panel and the funnel by dissolving at least a portion of the frit material with an organic acid solution, such as an aqueous carboxylic acid solution. German patent DE3901842 discloses a method that uses a high pressure water jet for cutting the tube into parts. U.S. Pat. No. 6,186,848 and German patent DE4003497 disclose a method that uses a water-cooled cutting blade for cutting tubes into parts.

US. patent application publication No. 2005/0020178A discloses a method that uses a CO₂ laser to separate the front screen and conical funnel of A CRT. In this patent application, a focused laser beam focused with an output power of more than 1200 W is used to form a groove on the glass surface of the conical funnel section at a splitting point that is about 8-15 mm away from the joint between the front screen panel and the conical funnel section. After the splitting groove has been made, then, a fan or de-focus is used to heat the CRT so as to cause a temperature difference on the different sides of the groove in order to ensure the splitting of the parts. However, this method has some drawbacks. For example, the equipment and operation of a high power CO₂ laser generator is too expensive. In addition, the parameters used to form the groove should be selected carefully, otherwise the CRT will be blown into small parts or cannot be split from the groove due to thermal stress imbalances and pressure differences between inside vacuum and outside atmosphere on the CRT. This is particularly so when dealing with different sizes since larger CRTs have thicker glass.

### SUMMARY OF THE INVENTION

Therefore, the present invention provides processes and apparatuses for separating two bonded parts at their joint, where the joint is formed by frit materials such as organic resins. The processes and apparatuses employ a laser beam that burns out the joint but has little effect on the two bonded parts because the laser beam is transparent or with minimum absorption to the two bonded parts.

One embodiment of the present invention provides a laser selective separation apparatus for separating two parts being bonding together at a joint by bonding material. The laser selective separation apparatus comprises a laser generator for providing a laser beam with a wavelength range that can melt or burn out the bonding material but cause no substantial changes of the bonded two parts, a light guiding module for guiding the laser beam during the operation of the laser selective separation apparatus, and a focal module for receiving the laser beam from the light guiding module, and converging and focusing and casting the laser beam onto the joint so that the bonding material can be melted or burnt out, thereby when all the bonding material bonding the two parts is melted or burnt out, the bonded two parts can be separated.

In another embodiment of the laser selective separation apparatus, the two parts are the front screen panel and conical funnel section respectively of a cathode-ray tube, where the front panel and conical funnel section are bonded together by frit material. In a further embodiment of the laser selective separation apparatus, when the cathode-ray tube is being separated, the laser generator is a Nd: YAG laser with wavelength 1064 nm or a fiber laser with wavelength 1070 nm.

In another embodiment of the laser selective separation apparatus, the light guiding module comprises a plurality of reflectors or fiber optics, where the plurality of reflectors or fiber optics are so configured that they can produce a desired laser beam and guide the laser beam.

In another embodiment of the laser selective separation apparatus, the focal module comprises one or more focal lens that converge the laser beam into a focused beam that is cast at the joint to melt or burn out the bonding material.

In another embodiment of the laser selective separation apparatus, it further comprises a debris removing module for removing the burnt debris so that the laser beam can continuously interact with the bonding material. In a further embodiment of the laser selective separation apparatus, the debris removing module comprises a gas resource for providing a gas jet, and a nozzle being operably directed at the same location as the one directed by the laser beam, where when the gas jet is passed through the nozzle; the gas blows away the debris and fumes produced by the laser beam. In another further embodiment of the laser selective separation apparatus, the gas resource is compressed air or a compressed gas.

In another embodiment of the laser selective separation apparatus, it further comprises a cleaning module for cleaning the debris and fume produced in the process of burning the bonding material by the laser beam.

In another embodiment of the laser selective separation apparatus, it further comprises an operating platform that is capable of rotating and moving the to-be-separated two parts.

In another embodiment of the laser selective separation apparatus, it further comprises an alignment module for providing a coaxial visible guide laser beam that is adopted to assist aligning the focused beam with the bonding material.

In another embodiment of the laser selective separation apparatus, it further comprises a microprocessor with embedded computer-executable programs that electronically communicates with individual components of the laser selective separation apparatus.

Another embodiment of the present invention provides a process for separating two parts being bonding together at a joint by bonding material. The process comprises generating by a laser generator for a laser beam with a wavelength range that can melt or burn out the bonding material but cause no substantial changes of the bonded two parts, guiding the laser beam by a light guiding module during the operation of the laser selective separation apparatus, and receiving the laser beam from the light guiding module, and converging and focusing and casting the laser beam onto the joint so that the bonding material can be melted or burnt out by a focal module, thereby when all the bonding material bonding the two parts is melted or burnt out, the bonded two parts can be separated.

In another embodiment of the process, the two parts are the front screen panel and conical funnel section respectively of a cathode-ray tube, where the front panel and conical funnel section are bonded together by frit material; and wherein when the cathode-ray tube is being separated, the laser generator is a Nd: YAG laser with wavelength 1064 nm or a fiber laser with wavelength 1070 nm.

In another embodiment of the process, it further comprises removing the burnt debris by a debris removing module so that the laser beam can continuously interact with the bonding material; wherein the debris removing module comprises a gas resource for providing a gas jet, and a nozzle being operably directed at the same location as the one directed by the laser beam, where when the gas jet is passed through the nozzle; the gas blows away the debris and fumes produced by the laser beam; and wherein the gas resource is compressed air or a compressed gas.

In another embodiment of the process, it further comprises cleaning by a cleaning module the debris and fume produced in the process of burning the bonding material by the laser beam.

In another embodiment of the process, it further comprises rotating and moving the to-be-separated two parts by an operating platform.

In another embodiment of the process, it further comprises aligning the focused beam with the bonding material by an alignment module for providing a coaxial visible guide laser beam that is adopted to assist the alignment.

In another embodiment of the process, it further comprises removing residual bonding material. In a further embodiment of the process, the residual bonding material is removed by a grinding wheel or a laser divergent beam.

The objectives and advantages of the invention will become apparent from the following detailed description of preferred embodiments thereof with the accompanying drawings.

### BRIEF DESCRIPTION OF THE DRAWINGS

Preferred embodiments according to the present invention will now be described with reference to the Figures, in which like reference numerals denote like elements.

FIG. 1 is a function block diagram of a laser selective separation apparatus in accordance with one embodiment of the present invention.

FIG. 2 is a function block diagram of the coaxial visible guide laser beam configured within the laser selective separation apparatus in accordance with one embodiment of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

In the following detailed description, specific details are set forth in order to provide a thorough understanding of the invention. However, it will be understood by those skilled in the relevant art that the present invention may be practiced without these specific details. In other instances, well-known methods, procedures, components, and materials have not been described in detail so as not to obscure the present invention.

While the principles of the present invention will be illustrated by separating the two different types of glasses in various Cathode-Ray Tubes (CRTs), their applications are not so limited. It is well known that more and more industrial and consumer goods contain components that are comprised of different parts joined together by one or more bonding materials. The bonding materials such as adhesive epoxies provide convenience for manufacturing processes and lower manufacturing costs. However, as shown in CRTs, the bond between two parts is usually quite narrow, rendering it extremely difficult to separate the bonded two parts by common techniques such as sawing and cutting. Therefore, whenever the bonding materials have different thermal absorbance from the bonded parts, it is possible to apply the principles of the present invention by selecting a laser with a wavelength range that can be absorbed by the bonding materials but have no substantial effects on the bonded parts so that the bonding materials can be melted or burnt out, resulting in the separation of the bonded parts. In addition, intact and clean separation of bonded parts makes it feasible to rework on certain parts during manufacturing processes, reducing manufacturing costs.

The present invention provides methods and apparatuses for separating two parts that are bonded together by one or more bonding materials. Briefly, the separation is done by selecting a laser with a wavelength range that can melt or burn out the bonding materials but have no substantial effects on the bonded parts such as melting or burning out. In certain circumstances, as long as the selected laser beam melts or burns out the bonding materials but does not melt the bonded parts, it can be applicable for the present invention because it can separate the bonded parts. Therefore, the selection of a suitable laser beam depends on the characteristics of the bonded parts and the bonding materials.

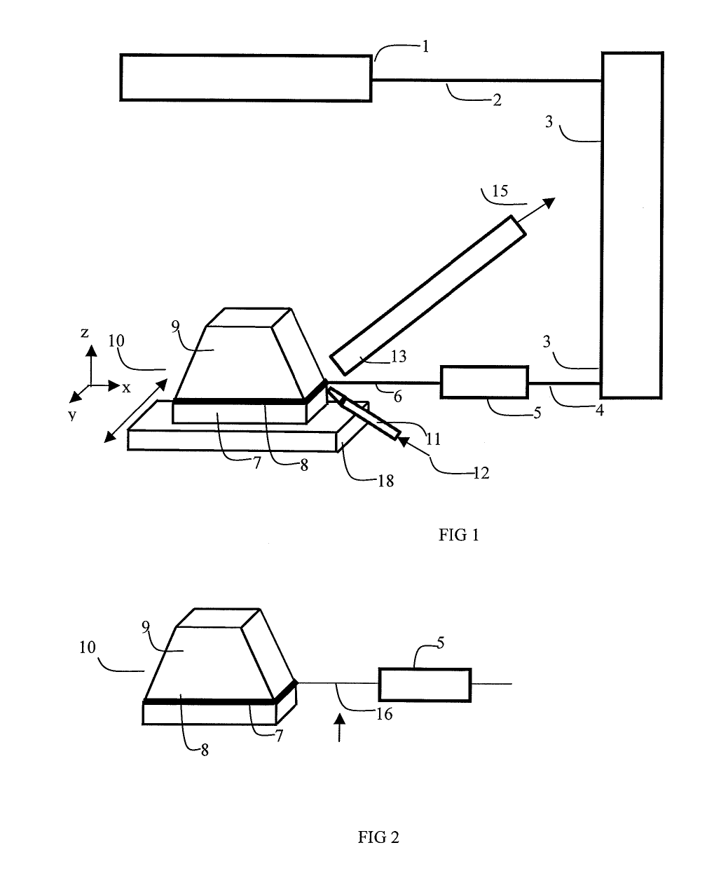

Now referring to FIG. 1, there is provided a function block diagram of a laser selective separation apparatus in accordance with one embodiment of the present invention. The laser selective separation apparatus 100 as shown in FIG. 1 is applicable for separating the front panel glass 7 from the conical funnel glass 9 in a CRT 10, where the front panel glass 7 and conical funnel glass 9 are bonded together by the frit material 8. The laser selective separation apparatus 100 comprises a laser generator 1, a light guiding module 3, and a focal module 5. The laser generator 1 provides a laser beam 2 with a wavelength range that is transparent for or absorbed minimally by the front and conical funnel glasses but absorbed by the frit material. For instance, the laser generator 1 may be a Nd: YAG laser with wavelength 1064 nm or a fiber laser with wavelength 1070 nm. The light guiding module 3 comprises a plurality of reflectors or fiber optics; when the laser beam 2 passes through the light guiding module 3, it becomes a laser beam 4 that is then guided on the surface of the focal module 5. The focal module 5 comprises one or more focal lens that converge the laser beam 4 into a focused beam 6 that is cast on the frit material 8 to burn out the frit material 8. Since the front panel glass 7 and conical funnel glass 9 is transparent or with minimal absorption for the laser beam, the laser beam 6 is able to interact deeply with the frit material 8 through the glass material easily but not to interact with glass material; thus the front panel glass 7 and conical funnel glass 9 can be separated. The advantageous features of the laser selective separation apparatus 100 include that the problem of CRT blowout caused by thermal imbalance can be avoided, and that the laser power required is lower.

Still referring to FIG. 1, the laser selective separation apparatus 100 further comprises a debris removing module for removing the burnt debris so that the laser beam 6 can continuously interact with the frit material 8. In one embodiment, the debris removing module comprises a gas resource for providing a gas jet 12 that passes a nozzle 11; the gas jet 12 is directed to the interacting location between the laser beam and the frit material by the nozzle 11. The gas resource could be compressed air or other compressed gases such as nitrogen. The laser selective separation apparatus 100 may further comprise a cleaning module for cleaning the fume 15 produced in the process of burning the frit material by the laser beam. The cleaning module comprises a ventilating fan 13 that draws out the fume and debris. The laser selective separation apparatus 100 may further comprise a CRT operating platform 18 that is capable of rotating and moving the to-be-separated CRT in x-, y-, and z-directions, where the operations of the CRT operating platform can be achieved by any known means.

Now referring to FIG. 2, the laser selective separation apparatus 100 may further comprise an alignment module for providing a coaxial visible guide laser beam 16 that is adopted to assist aligning the focused beam 6 with the frit material 8.

The laser selective separation apparatus 100 may further comprise a microprocessor with embedded computer-executable programs that electronically communicates with the laser generator 1, the light guiding module 3, the focal lens 5, the debris removing module, the cleaning module, the CRT operating platform, and the alignment module. The microprocessor is also capable of receiving instructions from a user for separating a specific CRT so that it can provide instructions to each component of the apparatus.

The CRT that can be applied by the present invention may be from any electronic products including TVs, PC monitors and monitors for special applications.

Now there is provided a brief description of a process for separating the front panel glass from the conical funnel glass of a CRT in accordance with one embodiment of the present invention. When a CRT 10 is positioned on the surface of the CRT operating platform 18, the visible guide laser beam 16 is aligned on the frit material 8 at one end of the CRT. Then, the focal module 5 is adjusted to a suitable position so that the focused beam 6 has a preferable focal size on the frit material 8 of the CRT 10. Then, the laser generator 1 is fired, and the focused beam 6 begins to burn out or melt the frit material 8. In order to make sure that the focused beam 6 is always in contact with un-burnt frit material, the CRT is moved by the CRT operating platform 18 at a pre-set speed, or the focused beam 6 is moved at a pre-set speed. During the process, the gas flow from the nozzle 11 blows out the melted debris and the ventilating fan 13 cleans the fume 15 and melted debris. Due to the melting of the frit material, a kerf is generated in the joint between the front panel glass and conical funnel glass of the CRT 10. In one embodiment, the separating process for one CRT may be done continuously. One another embodiment, the separating process may be staged. For example, when the frit material 8 on one side CRT is burnout by the focused laser beam 6, the laser generator 1 is off and the focal lens 5 is moved in x-direction, and then, rotate the operating platform 18 at 90° to make another side frit material 8 of the CRT towards to the laser focused beam 6. The above procedure is repeated till the frit material 8 around the CRT has been removed. Finally, the front panel 7 and the conical funnel 9 can be separated easily.

Since the laser beam selected is transparent or with minimum absorption for the glass material so that the separated glass material of both the front panel and the conical funnel are all intact and no mixture material between the front panel and the conical funnel is generated. However, there is a possibility that residual frit material remains on the front panel and conical funnel glasses. In order to obtain pure separated glasses, the residual frit materials may be removed by a grinding wheel or a laser divergent beam.

Compared with the CO₂ laser grooving technique as mentioned above, the present invention has many advantages in separating the front screen panel and the conical funnel section of a CRT. First, the selected laser beam burns out only frit material in the joint between the front panel and the conical funnel without melting the glass material so that the blowout of the CRT caused by unsuitable parameters for grooving in the CO₂ laser grooving technique can be avoided. Second, no matter what CRT size and glass thickness, there is no blowout caused by thermal stress imbalances and pressure differences between inside vacuum and outside atmosphere on the CRT. Third, lower laser power is needed (about 400W) because the frit material melting temperature is lower than the glass material and no gas medium consumption in laser cavity happens during laser working so that the cost of both laser equipment and operation is much lower. Fourth, a clean recycling environment can be achieved since the glass material is kept intact during laser separating process so that no glass debris produced. The fume only from burning frit can be easily drawn out by the ventilating fan. Finally, a high speed of laser separating process can be obtained so that a high efficiency of recycling process can be achieved.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A laser selective separation apparatus for separating two parts being bonding together at a joint by bonding material, comprising:
a laser generator for providing a laser beam with a wavelength range that can melt or burn out the bonding material but causes no substantial changes of the bonded two parts;
a light guiding module for guiding the laser beam during the operation of the laser selective separation apparatus; and
a focal module for receiving the laser beam from the light guiding module, and converging and focusing and casting the laser beam onto the joint so that the bonding material can be melted or burnt out,
thereby when all the bonding material bonding the two parts is melted or burnt out, the bonded two parts can be separated.

2. The laser selective separation apparatus of claim 1, wherein the two parts are the front screen panel and conical funnel section respectively of a cathode-ray tube, where the front panel and conical funnel section are bonded together by frit material.

3. The laser selective separation apparatus of claim 2, wherein when the cathode-ray tube is being separated, the laser generator is a Nd: YAG laser with wavelength 1064 nm or a fiber laser with wavelength 1070 nm.

4. The laser selective separation apparatus of claim 1, wherein the light guiding module comprises a plurality of reflectors or fiber optics, where the plurality of reflectors or fiber optics are so configured that they can produce a desired laser beam and guide the laser beam.

5. The laser selective separation apparatus of claim 1, wherein the focal module comprises one or more focal lens that converge the laser beam into a focused beam that is cast at the joint to melt or burn out the bonding material.

6. The laser selective separation apparatus of claim 1, further comprising a debris removing module for removing the burnt debris so that the laser beam can continuously interact with the bonding material.

7. The laser selective separation apparatus of claim 6, wherein the debris removing module comprises a gas resource for providing a gas jet, and a nozzle being operably directed at the same location as the one directed by the laser beam, where when the gas jet is passed through the nozzle; the gas blows away the debris and fumes produced by the laser beam.

8. The laser selective separation apparatus of claim 7, wherein the gas resource is compressed air or a compressed gas.

9. The laser selective separation apparatus of claim 1, further comprising a cleaning module for cleaning the debris and fume produced in the process of burning the bonding material by the laser beam.

10. The laser selective separation apparatus of claim 1, further comprising an operating platform that is capable of rotating and moving the to-be-separated two parts.

11. The laser selective separation apparatus of claim 1, further comprising an alignment module for providing a coaxial visible guide laser beam that is adopted to assist aligning the focused beam with the bonding material.

12. The laser selective separation apparatus of claim 1, further comprising a microprocessor with embedded computer-executable programs that electronically communicates with individual components of the laser selective separation apparatus.

13. A process for separating two parts being bonding together at a joint by bonding material, comprising the following steps of:
generating by a laser generator for a laser beam with a wavelength range that can melt or burn out the bonding material but causes no substantial changes of the bonded two parts;
guiding the laser beam by a light guiding module during the operation of the laser selective separation apparatus; and
receiving the laser beam from the light guiding module, and converging and focusing and casting the laser beam onto the joint so that the bonding material can be melted or burnt out by a focal module,
thereby when all the bonding material bonding the two parts is melted or burnt out, the bonded two parts can be separated.

14. The process of claim 13, wherein the two parts are the front screen panel and conical funnel section respectively of a cathode-ray tube, where the front panel and conical funnel section are bonded together by frit material; and wherein when the cathode-ray tube is being separated, the laser generator is a Nd: YAG laser with wavelength 1064 nm or a fiber laser with wavelength 1070 nm.

15. The process of claim 13, further comprising a step of removing the burnt debris by a debris removing module so that the laser beam can continuously interact with the bonding material; wherein the debris removing module comprises a gas resource for providing a gas jet, and a nozzle being operably directed at the same location as the one directed by the laser beam, where when the gas jet is passed through the nozzle; the gas blows away the debris and fumes produced by the laser beam; and wherein the gas resource is compressed air or a compressed gas.

16. The process of claim 13, further comprising a step of cleaning by a cleaning module the debris and fume produced in the process of burning the bonding material by the laser beam.

17. The process of claim 13, further comprising a step of rotating and moving the to-be-separated two parts by an operating platform.

18. The process of claim 13, further comprising a step of aligning the focused beam with the bonding material by an alignment module for providing a coaxial visible guide laser beam that is adopted to assist the alignment.

19. The process of claim 13, further comprising a step of removing residual bonding material.

20. The process of claim 19, wherein the residual bonding material is removed by a grinding wheel or a laser divergent beam.
